(19) United States
(12) Patent Application Publication
(10) Pub. No.: US 2014/0287860 A1
(43) Pub. Date: Sep. 25, 2014

(54) TENSIONER WITH DAMPING STRUCTURE MADE FROM TWO COMPONENTS WITH NO ROTATIONAL PLAY THEREBETWEEN

(71) Applicant: Litens Automotive Partnership, Woodbridge (CA)

(72) Inventors: Wei Ma, Richmond Hill (CA); Gerald J. Hamers, Woodbridge (CA)

(73) Assignee: Litens Automotive Partnership, Woodbridge (CA)

(21) Appl. No.: 14/352,563

(22) PCT Filed: Oct. 10, 2012
(86) PCT No.: PCT/CA2012/000999

§ 371 Date: Apr. 17, 2014

Related U.S. Application Data
(60) Provisional application No. 61/551,740, filed on Oct. 26, 2011.

(51) Int. Cl. F16H 7/08

(52) U.S. Cl. CPC F16H 7/08; F16H 2007/0842
USPC 474/135

(57) ABSTRACT

In an aspect, a tensioner is provided, comprising a base, a tensioner arm, a tensioner spring, a wheel, and a damping structure. The base is mountable to an engine. The tensioner arm is pivotally connected to the base for movement about a tensioner arm axis. The tensioner spring is connected between the base and the tensioner arm and is positioned to urge the tensioner arm towards a free arm position. The wheel is rotatably mounted to the tensioner arm and is engageable with an endless drive member. A friction surface is provided on one of the base and the tensioner arm. The damping structure is provided on the other of the base and the tensioner arm and engages the friction surface to generate friction during rotation of the tensioner arm. The damping structure includes a sleeve that contains at least one aperture and a damping element that contains at least one lug that engages the at least one aperture with no circumferential clearance therebetween.

### CROSS-REFERENCE TO RELATED APPLICATIONS

This application claims the benefit of U.S. Provisional Patent Application No. 61/551,740, filed Oct. 26, 2011, which is hereby incorporated by reference in its entirety.

### FIELD

This disclosure relates to tensioners for powered devices, and in particular for internal combustion.

### BACKGROUND

Tensioners are devices that may be used to maintain tension in an endless drive member such as a belt, that is driven by en engine and that is used to drive accessories such as one or more of an alternator, a water pump, an air conditioning compressor, a power steering pump and/or other devices.

Situations arise where the belt undergoes rapid increases and decreases in tension as a result of engine torsionals and other events. Torsionals are torsional vibrations that can occur with any internal combustion engine, and particularly with certain engines such as those with a low cylinder count (e.g. four cylinders or less), diesel engines, or other naturally less-than-perfectly balanced engines. Such torsionals can affect the tensioner by causing rapid oscillations of the tensioner arm, which generally have negative impact on the longevity of the tensioner and can in some instances result in the tensioner pulley being thrown off the belt temporarily. It is generally desirable to dampen these motions of the tensioner arm, particularly in the direction away from the belt.

Some damping structures that are proposed include a metallic sleeve and a polymeric damping element that is assembled to the sleeve by means of lugs on the damping element and apertures on the sleeve. Some amount of dimensional tolerance exists in the manufacture of the two components and so in order to reduce the likelihood of the two components being unable to mate together, the lugs are made to have clearance with the apertures. Unfortunately, this clearance can negatively impact the performance of the damping structure and the ability of the tensioner to dampen motions of the tensioner arm.

Partial or complete solutions to this problem and other problems would be beneficial.

### SUMMARY

In an aspect, a tensioner is provided, comprising a base, a tensioner arm, a tensioner spring, a wheel, and a damping structure. The base is mountable to an engine. The tensioner arm is pivotally connected to the base for movement about a tensioner arm axis. The tensioner spring is connected between the base and the tensioner arm and is positioned to urge the tensioner arm towards a free arm position. The wheel is rotatably mounted to the tensioner arm and is engageable with an endless drive member. A friction surface is provided on one of the base and the tensioner arm. The damping structure is provided on the other of the base and the tensioner arm and engages the friction surface to generate friction during rotation of the tensioner arm. The damping structure includes a sleeve that contains at least one aperture and a damping element that contains at least one lug that engages the at least one aperture with no circumferential clearance therebetween.

### BRIEF DESCRIPTION OF THE DRAWINGS

Embodiments will now be described, by way of example only, with reference to the attached drawings, in which:

FIG. 1 is a top plan view of an embodiment of a tensioner;

FIG. 2 is an exploded perspective view of the tensioner shown in FIG. 1;

FIG. 3 is a sectional side view of the tensioner shown in FIG. 1;

FIG. 4 is a perspective view of a portion of the tensioner shown in FIG. 1;

FIG. 5 is a graph illustrating the damping provided by a tensioner of the prior art;

FIG. 6 is a graph illustrating the damping provided by the tensioner shown in FIG. 1;

FIG. 7 is a perspective view of a damping structure that is part of the tensioner shown in FIG. 1;

FIG. 8 is a perspective view of an alternative damping structure for the tensioner shown in FIG. 1;

FIG. 9 is a perspective view of yet another alternative damping structure for the tensioner shown in FIG. 1;

FIG. 10 is a sectional perspective view of the damping structure shown in FIG. 9;

FIG. 11 is a perspective view of locating features for use in positioning the sleeve of the damping structures shown in FIGS. 7-10 in a mold for molding a damping element thereon;

FIG. 12 is a series of graphs illustrating the performance of the damping structure shown in Figure lover time, as compared to prior art damping structures;

FIG. 13 is a perspective view of another alternative damping structure for use in the tensioner shown in FIG. 1; and

FIGS. 14-19 are perspective views illustrating the assembly of the damping structure shown in FIG. 13.

### DETAILED DESCRIPTION

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments.

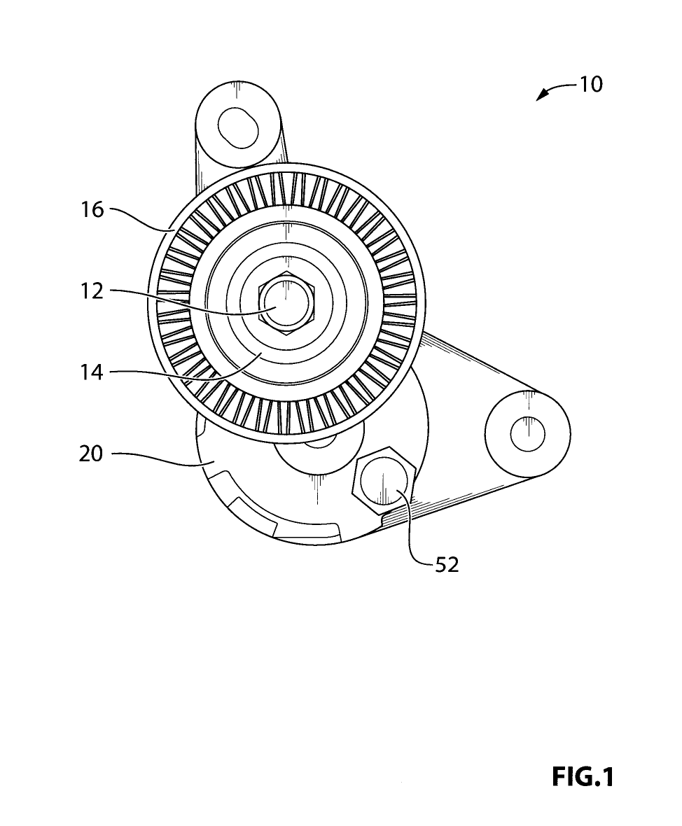

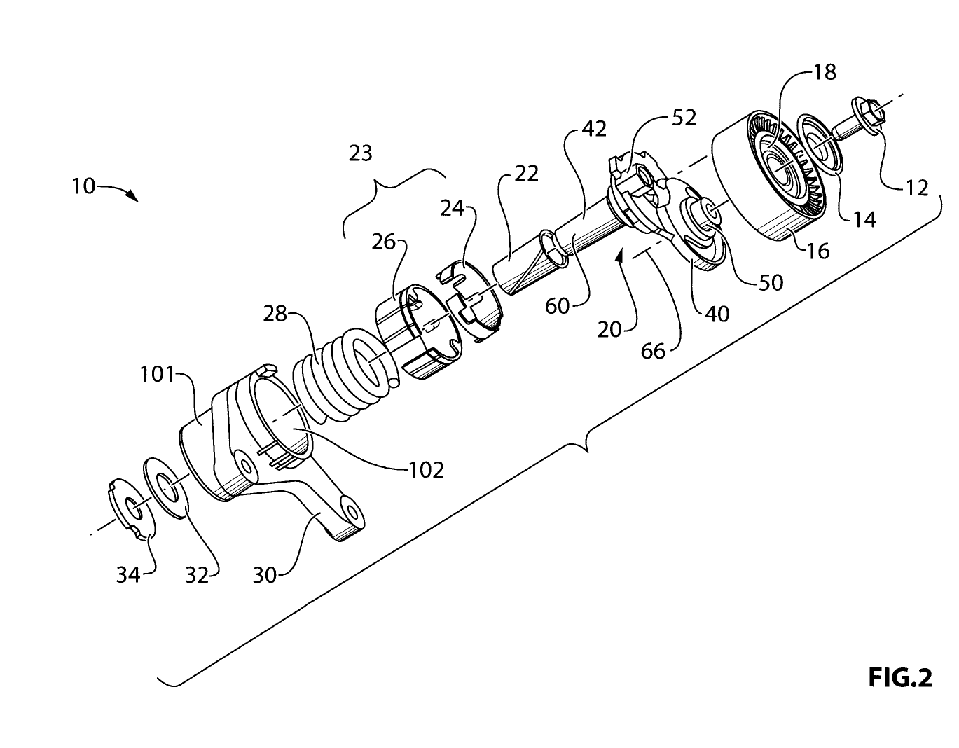

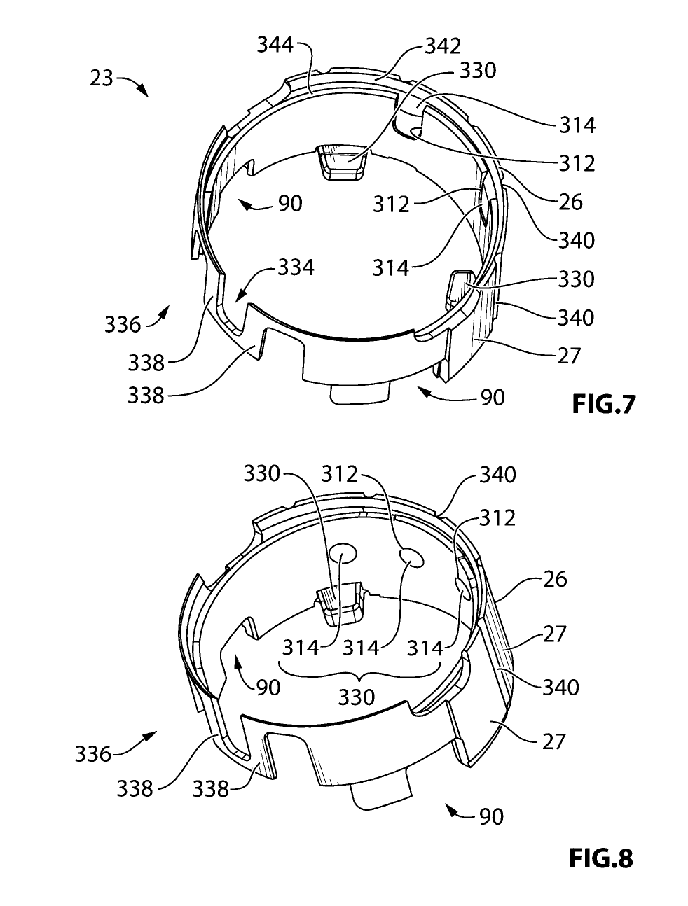

Reference is made to FIG. 1, which shows a tensioner 10. Referring to FIG. 2, the tensioner 10 may include a fastener 12 (e.g. a bolt), a dust shield 14, a wheel 16 (which may be, for example, a pulley), a bearing 18, a tensioner arm 20, a pivot bushing 22, a damping structure 23 (which may comprise a sleeve 24 and a damping element 26 as shown in FIG. 7), a spring 28, a base 30, a thrust washer 32 and a thrust plate 34. The components of the tensioner 10 aside from the damping structure 23 may be similar to the analogous components of the tensioner 10 shown in PCT publication WO2010037232 and US Patent publication US20090181815. The fastener 12, the dust shield 14, the bearing 18 and the thrust washer 32 may be generally conventional in their configuration.

The base 30 mounts fixedly to the engine block (not shown) or to some other fixed support member. The tensioner arm 20 is pivotally mounted, via the bushing 22, to the base 30 for pivotal movement about a tensioner arm axis 68. The tensioner arm 20 supports the bearing 18 thereon, which, in turn, supports the wheel 16 thereon for rotation about wheel axis 66. The spring 28 acts between the base 30 and the arm 20 and urges the arm 20 towards a free arm position that defines one end of travel for the arm 20.

When the tensioner 10 is mounted onto an engine block of the like, the wheel 16 engages a belt to maintain tension in the belt as a result of the urging on the arm 20 by the spring 28. The belt may be any suitable type of belt, such as, for example, an asynchronous belt such as a single- or poly-V belt, or a synchronous belt that has teeth. While the term ‘belt’ may be used for convenience, it will be noted that any endless drive member may be used.

As the belt stretches over its operating life, the tensioner arm 20 is continuously urged into the belt by the spring 28. By contrast, in some situations the belt tension increases momentarily, such as during engine startup, during hard acceleration, or during the startup of one or more belt-driven accessories, such as an alternator, an air conditioning compressor, a water pump, a power-steering pump, or any other suitable belt-driven accessory. In the event that the belt tension increases, the belt will urge the tensioner arm 20 in a direction away from the free arm position, towards a ‘load stop’ position. A damping structure 23 is provided to generate a frictional torque between the tensioner arm 20 and the base 30 to resist a torque applied by the belt on the tensioner arm 20 (through the wheel 16) during moments where the belt tension increases.

The damping structure 23 includes a sleeve 24 and a damping element 26. To assemble a sleeve and damping element of the prior art, there may one or more lugs on the damping element that engage one or more lug-receiving apertures in the sleeve. In order to facilitate their assembly, there is typically some amount of dimensional clearance between the lugs and apertures. As a result of this clearance, however, some relative movement in the rotational direction about axis 68 is permitted between the sleeve and the damping element. This clearance may be referred to as ‘play’ or ‘rotational play’. Such rotational play results in lost motion between the sleeve 24 and damping element 26.

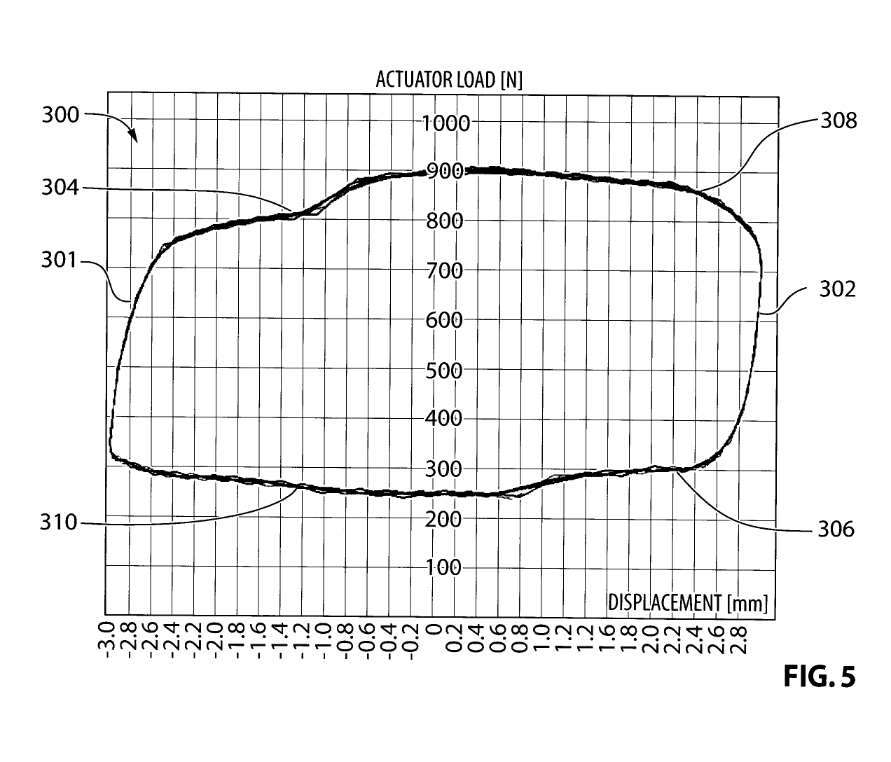

A curve illustrating the force exerted by such a prior art tensioner wherein such rotational play exists is shown at 300 in FIG. 5. As can be seen, when the tensioner arm reaches a first or second end in its path (represented by regions 301 and 302 respectively) and reverses direction, during some initial portion (represented by regions 304 and 306 of the curve 300) of the movement back towards the other end 300 or 302 of the path, there is relative movement between the sleeve and the damping element and as a result, the resistive force exerted on the tensioner arm is a certain value. Once the play has been taken up (as shown in regions 308 and 310), the sleeve and damping element move together, and as a result, the resistive force increases relative to the resistive forces in regions 304 and 306.

Over many cycles in which the tensioner arm reverses direction during operation of the engine, the play between the sleeve and the damping element may increase due to fatigue on the part of one or both of these components. As a result, the regions 304 and 306 of the curve 300 will grow and the tensioner arm will experience the higher damping force over less and less of its travel. Moreover, as the amount of play increases between the lugs on the damping element and the apertures on the sleeve, the speed of the sleeve and the damping element relative to each other when they engage each other will increase and thus the impact forces between them during engagement will increase, which in turn will accelerate the deformation of the lugs and/or apertures thereby worsening the problem.

Even where the amount of play is small, a small amount of lost motion relative to a large arm movement may be negligible as a percentage when looking at the output loop curves, or energy dissipation, but the same small amount of lost motion relative to a small or very small arm movement, or a high frequency, low amplitude oscillation (i.e. a “quiver”), could represent a significant degradation or change in the loop curve, and a reduction of its corresponding energy dissipation value.

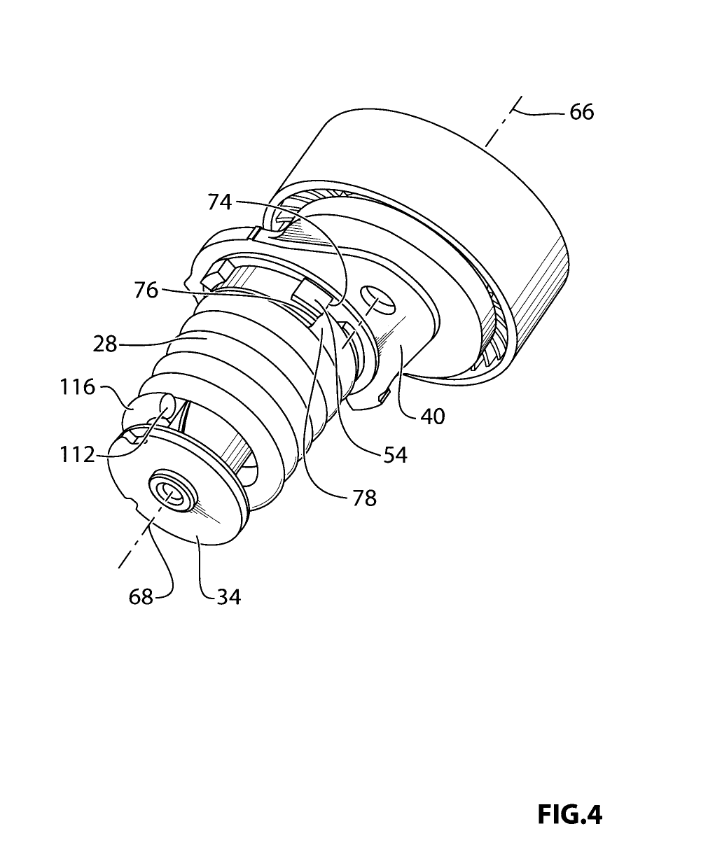

In an aspect, the damping structures 23 shown in FIGS. 7-19 are constructed so as to substantially eliminate play between the sleeve 24 and the damping element 26 that would permit relative movement in the rotational direction between them about axis 68. The sleeve 24 may be formed of an appropriate material, such as steel, and may be configured to engage the spring 28 and distribute the force exerted by the spring 28 onto the damping element 26. In the example provided, the sleeve 24 includes a window 90 through which a drive member 54 (FIG. 4) on the tensioner arm 20 passes to engage a first end 76 of the spring 22. Additionally, the window 90 may be sufficiently tightly fitting with the drive member 54 that the drive member 54 and the window 90 couple the sleeve 24 and the tensioner arm 20. A second window 90 may be provided in order to make the sleeve 24 capable of being used with tensioner arrangements having a spring that is of the opposite hand to the spring 22 shown in FIG. 2.

The damping element 26 may be formed of a resilient material, such as an unfilled (non-reinforced) nylon so as to flexibly conform to the interior surface of a cylindrical friction surface 102 formed in a drum 101 that may be coupled to the base 30. The damping element 26 has a damping surface 27 thereon that frictionally engages the circumferential surface 102 of the brake drum aperture 100 to dampen the torque that is transmitted about the second axis 68. It will be appreciated from this disclosure that the surface 104 of the clamping element 26 that contacts the circumferential surface 102 of the brake drum aperture 100 can be configured in a desired manner to control the distribution of force at given points along the surface 104 of the damping element 26.

With reference to FIG. 2, the curvature of the spring 28 can vary as a function of torque transmitted through the spring 28. As tensioner load increases or decreases, the arc of contact between spring 28 and damping structure 23 can vary (i.e., increase or decrease, respectively) such that the area over which the load is transmitted between the damping structure 23 and the base 30 can correspondingly increase or decrease, respectively. Accordingly, a desired range of pressure on the damping element 26 may be maintained.

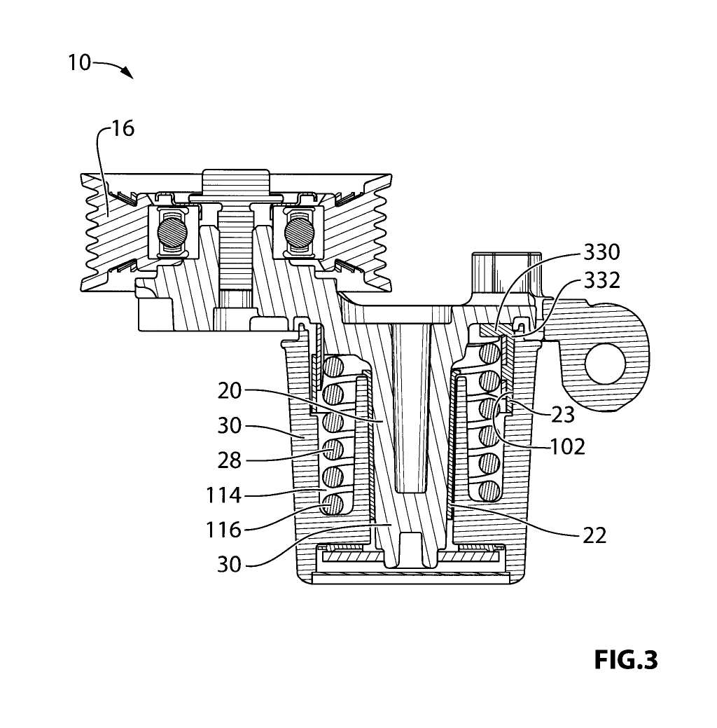

Returning to FIGS. 2 and 3, the spring 28 can be received into a spring pocket 110 formed in the base 30 concentric with a stem 60 on the base 30. A second end 112 (FIG. 4) of the spring 28 may engage the base 30 in a desired manner. For example, the spring pocket 110 can include a groove 114 into which a last coil 116 of the spring 28 can be received and the groove 114 can terminate at a drive surface (not shown) that is similar to the surface of the drive member 54 that the first end 76 of the spring 22 abuts.

In one embodiment, the damping element 26 is molded directly on the sleeve 24 (i.e. the damping element is overmolded on the sleeve). The molding step may be an injection molding step or it may be any other suitable type of molding step.

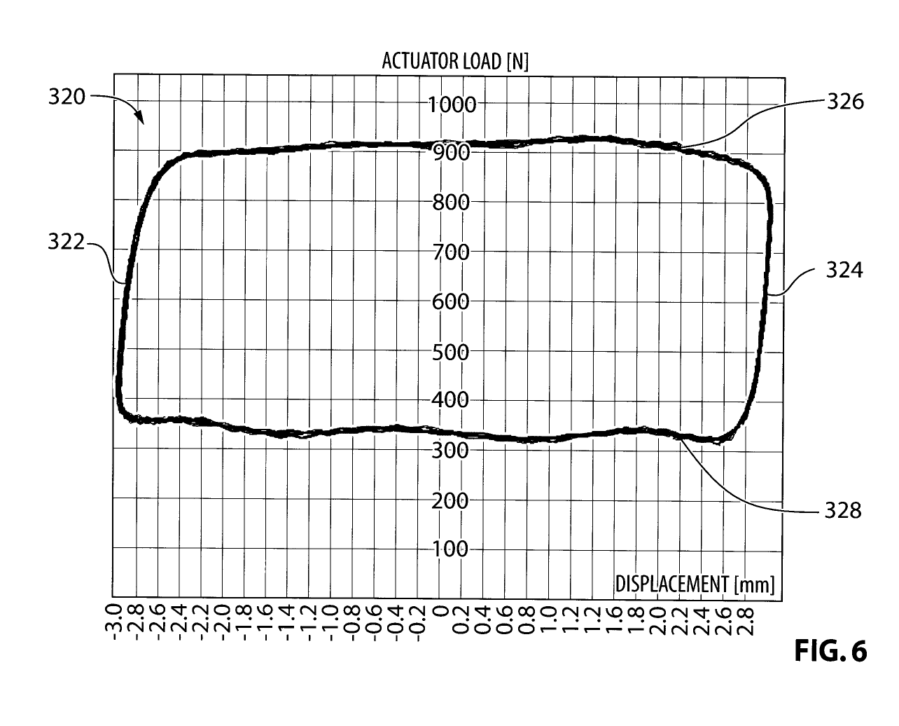

During the molding step molten material fills lug-receiving apertures shown at 312 in the sleeve 24 and hardens to form lugs 314. As a result there is no clearance between the lugs 314 and the apertures 312, and therefore there is no lost motion between them. As a result, the damping curve for the tensioner 10 with the damping structure shown in FIGS. 7-19 may be as shown at 320 in FIG. 6. As can be seen, the damping curve 320 includes regions 322 and 324 which represent the ends of the travel of the tensioner arm 20, and arm movement regions 326 and 328 which represent the damping force exerted on the tensioner arm during movement between the two ends of its path. As can be seen, because there is no lost motion between the sleeve 24 and the damping element 26, the damping force remains relatively consistent throughout the movement of the tensioner arm 20 even during the initial period of movement after the tensioner arm 20 reverses direction.

In the embodiment shown, the damping element 26 further includes a plurality of axial support members 330 that axially support the damping element 26 relative to the sleeve 24, that may additionally support the tensioner spring 28 and that may support the damping element 26 against a corresponding support surface 332 on the tensioner arm 20. The axial support members 330 may additionally assist in transmitting a damping force from the damping surface 27 on the damping structure 23 to the tensioner arm 20 during operation of the tensioner 10.

The sleeve 24 may be generally C-shaped. In other words it has a circumferential gap 334 and is therefore not fully enclosed circumferentially. In the gap 334, the damping member 26 may contain a flex portion 336 that includes a plurality of alternating generally axial segments 338. By providing the gap 334 and the flex portion 336, the damping structure can be easily compressed radially so as to permit it to easily be inserted within the radially inner surface 102 of the base 30 and then reexpanded to abut the surface 102.

The flex portion 336 may be recessed radially inwardly slightly relative to the damping surface 27 so as to inhibit the flex portion 336 from engaging the surface 102 on the base 30. This inhibits the flex portion 336 from incurring the stresses that would accompany frictional engagement, which could cause premature wear in that portion of the damping structure 23.

The damping element 26 includes collection grooves 340 for collecting dust that may accumulate during frictional engagement with the base 30, and/or debris that may inadvertently make its way between the surfaces 27 and 102 from outside the tensioner 10 or from elsewhere in the tensioner 10. By providing these grooves 340 such dust and debris can be kept from residing directly between the mating surfaces 27 and 102 where it could cause mechanical damage to one or both surfaces 27, 102.

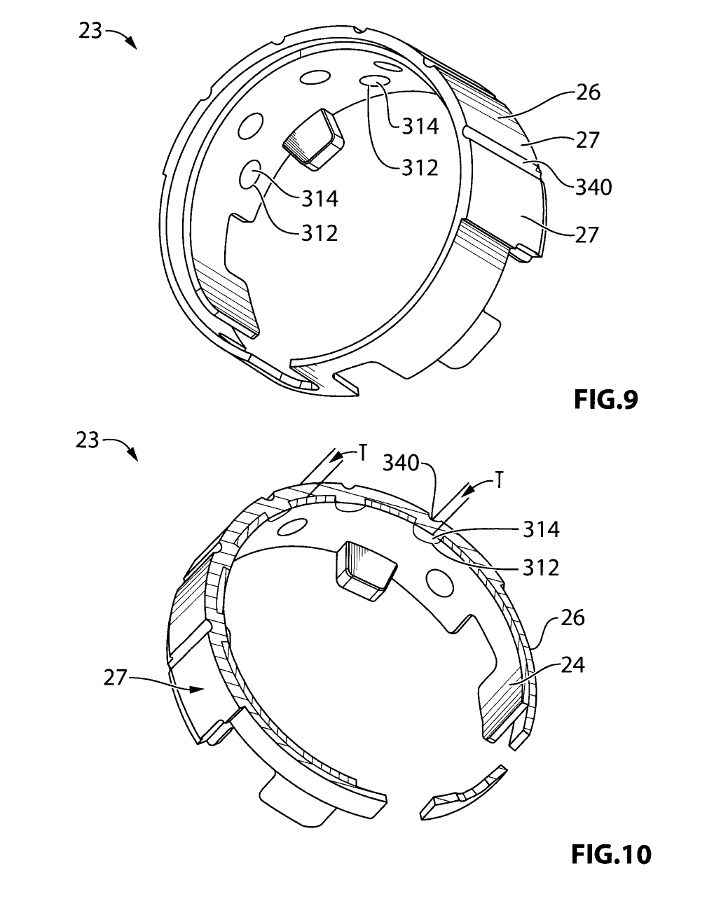

The damping element lugs 314 and the sleeve apertures 312 shown in FIG. 7 extend axially inwardly from axial edges 342 and 344 of the damping element 26 and the sleeve 24 respectively. However, other shapes for the lugs and apertures 314 and 312 may be utilized. For example, as shown in FIG. 8, a circumferential row 346 of generally circular lugs 314 may mate with a corresponding row of apertures 312 in the sleeve 24. As shown in FIG. 9, two rows 348 and 350 of lugs 314 engage apertures 312, wherein the apertures 312 in row 348 are offset axially with the apertures 312 in row 350. If the apertures 312 were aligned axially, there would be regions of the sleeve 26 that would have potentially large reductions in cross-sectional area in an axial-radial plane, which can reduce the strength of the sleeve 26 with respect to forces in the circumferential direction. By keeping the apertures 312 in the two rows 348 and 350 unaligned axially the presence of these circumferentially weakened regions in the sleeve 26 is inhibited.

As shown in the sectional view shown in FIG. 10, in some embodiments the grooves 340 may be positioned on the damping element 26 so as to be circumferentially aligned with lugs 314. As a result, the radial reduction in thickness (shown at T) of the damping element 26 that results from the presence of a groove 340 is at least partially mitigated by the presence of the lug 314, thereby at least partially mitigating any reduction in strength that results from the presence of the groove 340.

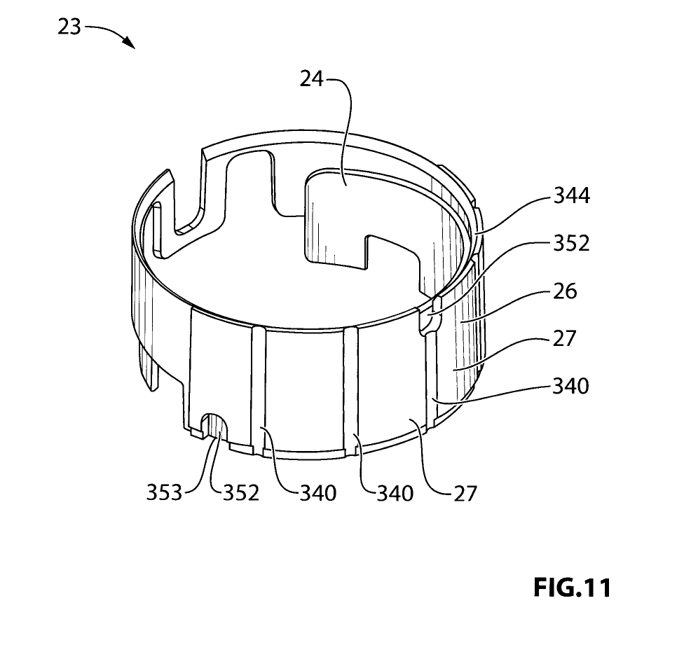

Referring to FIG. 11, sleeve-exposing cutouts 352 may be provided in the damping element 26. These cutouts 352 permit the molding machine that is used to overmold the damping element 26 on the sleeve 24 to locate the sleeve 26 in a selected position on the mold plates of the molding machine prior to injection of the material of the damping element 24. In some embodiments, the cutouts 352 may be provided at a plurality of locations circumferentially spaced from one another and along at least one and optionally both axial edges 344 and 353 of the sleeve 24.

While there may be an increased cost to overmold the damping element 26 to the sleeve 24 relative to the simple molding of a damping element 26 alone, the manufacture of the damping structure 23 does not require a final step of assembling the damping element 26 to the sleeve 24. This elimination of a manufacturing step (i.e. the aforementioned assembly step) may at least partially mitigate the increased cost associated with overmolding the damping element 26.

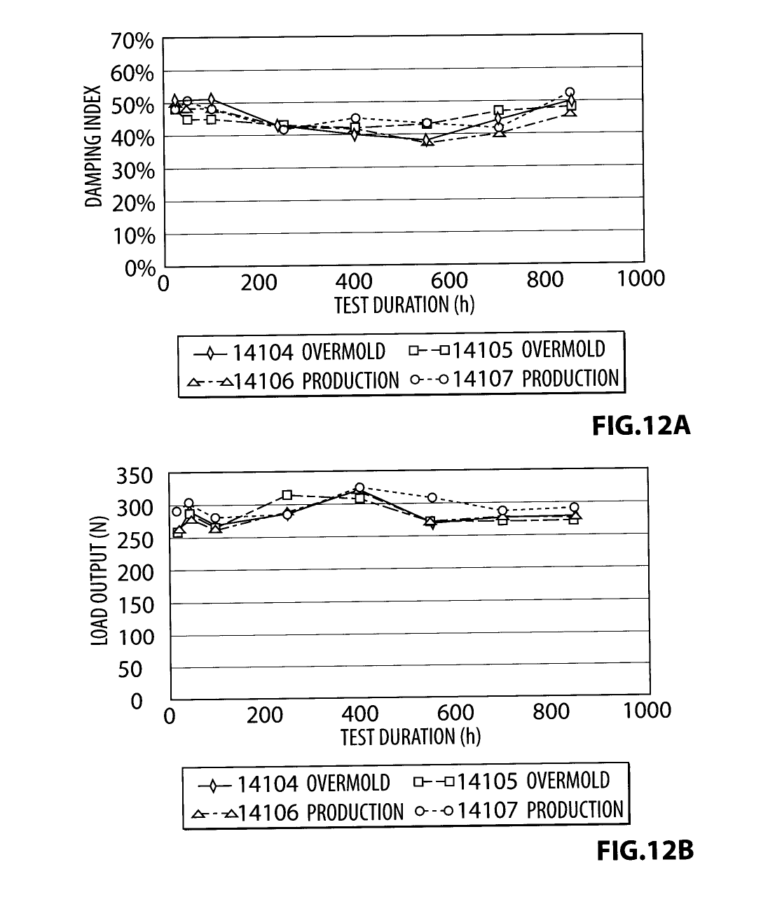

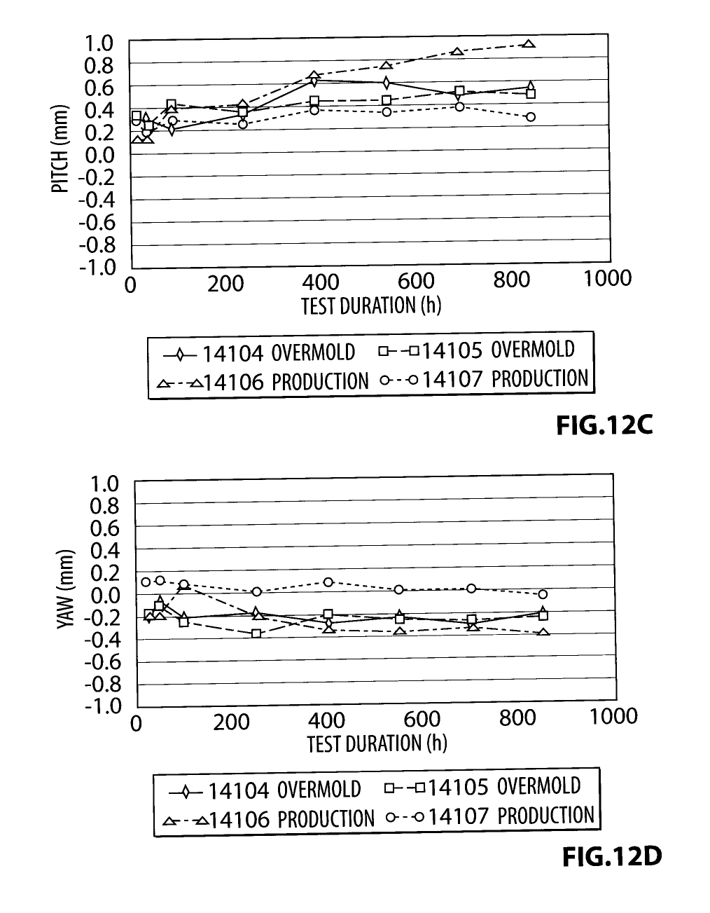

FIG. 12 shows several graphs illustrating the performance of two overmolded damping structures 23 relative to two damping structures that are assembled in accordance with the prior art. As can be seen, the performance of the overmolded damping structures 23 is similar to that of the non-overmolded version over several hundred hours of operation at +/−3.3 degrees of oscillation from the nominal tensioner arm position at 30 Hz.

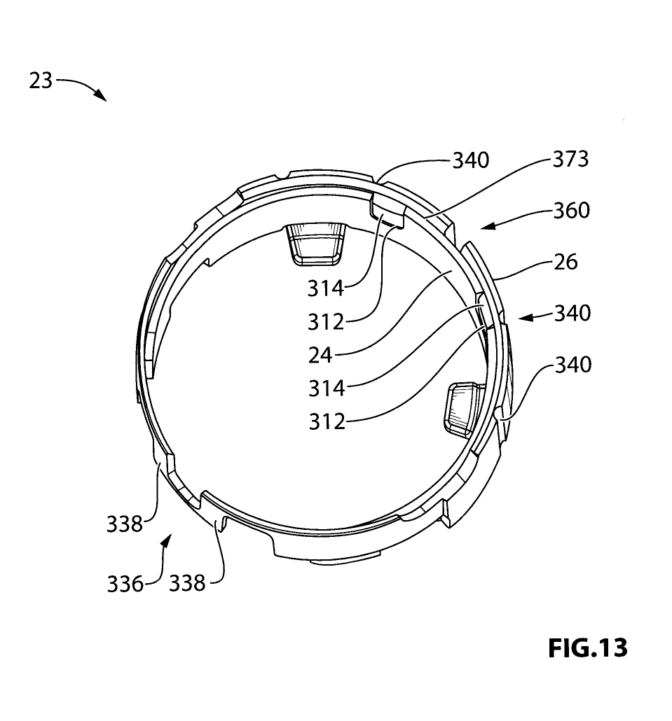

With reference to FIG. 13, instead of overmolding the damping element 26 onto the sleeve 24, the damping element 26 may be manufactured (e.g. by molding) and may be assembled to the sleeve 24 by mechanical press-fit together in such a way so as to eliminate any rotational play between lugs 314 and apertures 312 them. For example, the sleeve 24 may include first and second apertures 312, which may optionally be in the form of slots. The first and second apertures 312 are circumferentially spaced from each other. The damping element 26 may include first and second lugs 314 which are circumferentially spaced from each other.

The lugs 314 may be sized to have a press-fit relationship with the apertures 312 in the sleeve 24. The axially extending dimension-adjustment aperture 360 positioned circumferentially between the lugs 314 provides flexibility to the damping element 26 so that it may be flexed to bring the lugs 314 closer together or farther apart circumferentially as needed so that they align with the apertures 312 in the sleeve 24. By providing this flexing capability to the damping element 26, certain dimensional tolerances can be accommodated, and do not have to be compensated for by making the lugs 314 smaller than apertures 312. The dimension adjustment aperture 360 may be an open ended slot, as shown in FIG. 13, or it may alternatively be a slot that is closed at both ends but that still permits circumferential compression of the damping element 26.

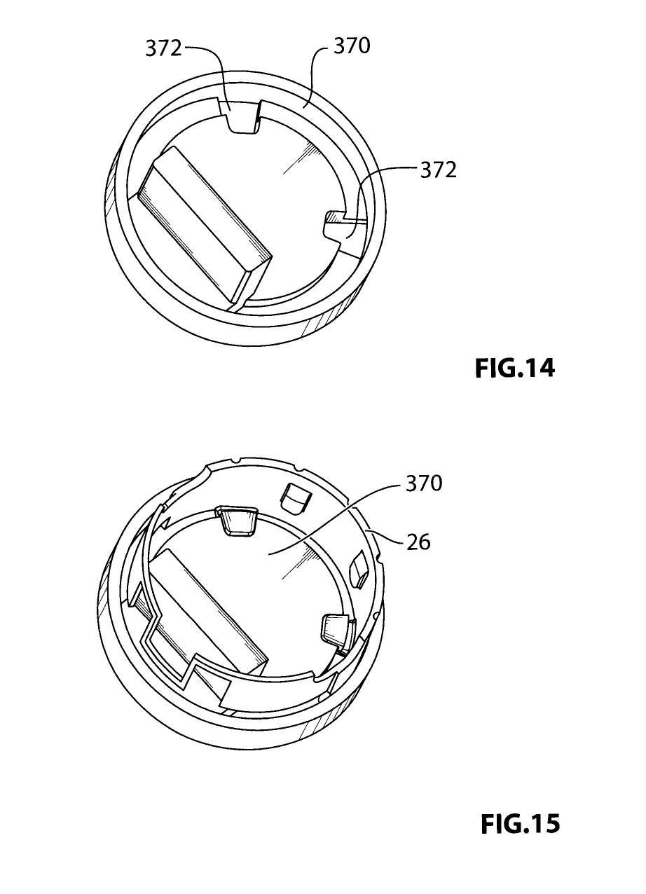

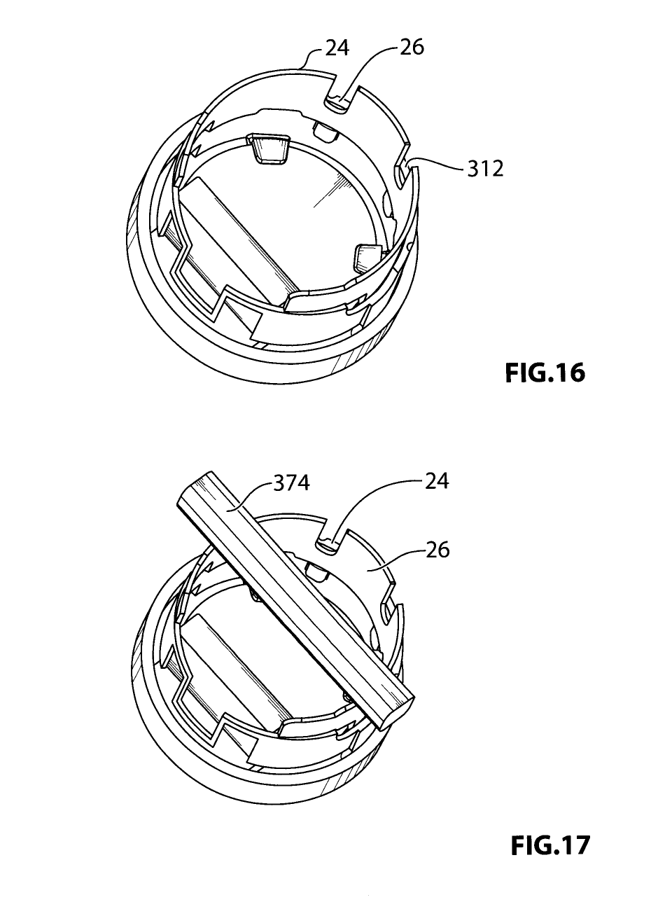

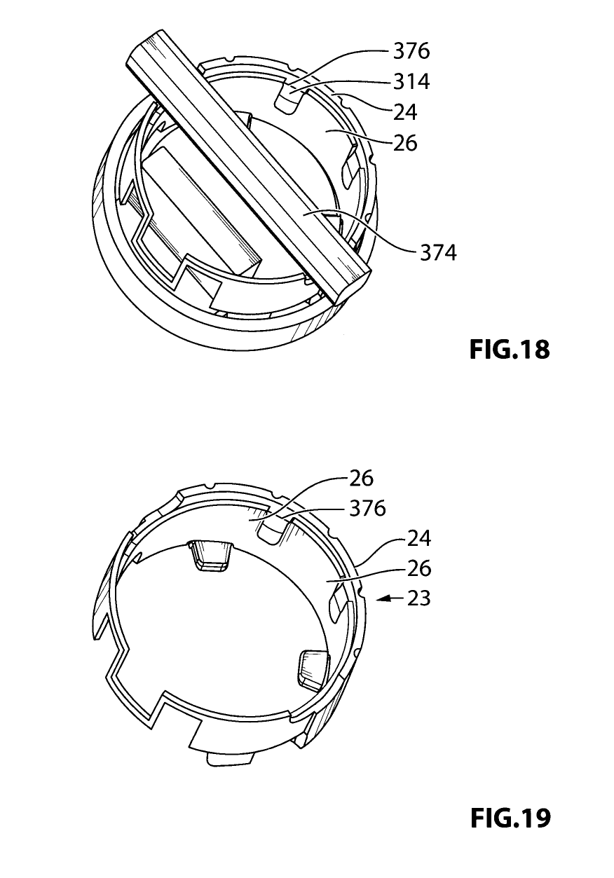

To assemble the damping structure 23, the lugs 314 can be pressed into the apertures 312 in the sleeve 24. FIGS. 14-19 illustrate an exemplary way of assembling the damping structure 23. As shown in FIG. 14, a base tool 370 is provided. The damping element 26 is inserted into the base tool 370 in FIG. 15 such that the axial support members 330 are received in receiving apertures 372 in the base tool 370, thereby locating the damping element 26 circumferentially (i.e. angularly) relative to the base tool 370. In FIG. 16, the sleeve 24 is compressed radially and is inserted in the damping element 26. A push tool 374 (FIGS. 17-18) may be used to push the sleeve down (i.e. axially) into position within the damping element 26. Lead-in surfaces 376 may be provided on the lugs 314 to permit the sleeve 24 to slide therepast. FIG. 19 shows the damping element 23 fully assembled.

Alternatively, the sleeve 24 may be radially compressed and brought axially into the contained volume of the damping element 24 and then may be permitted to expand until it engages the lugs 314. Due to the lack of clearance between the apertures 312 and the lugs 314 the lugs 314 may not fully insert into the apertures 312. A device such as a balloon or other inflatable device may be inserted into the contained volume of the sleeve 24 and expanded so as to force the sleeve 24 radially outward to force the lugs 314 to fully insert into the apertures 312. As a result, the lugs 314 and apertures 312 would mate with no clearance between them and therefore no lost motion.

In any of the embodiments described above, it may be possible to treat the radially outer surface 373 (see FIG. 13) of the sleeve 24 with a rough surface finish or treatment, such as Wacker EKaGrip frictional foil or Wacker EKaGrip frictional coating, inhibit any relative motion between the sleeve 24 and the damping element 26 particularly in embodiments wherein the two components are assembled together. Alternatively, the radially outer surface 373 may be treated with sandblasting, mechanical knurling, or the addition of axially oriented striations (sharp raised ribs or grooves) into the surface of the metal, to enhance the frictional properties and mechanical locking between the polymeric damping element 26 and the metallic sleeve 24. Additionally or alternatively, the two components 26 and 24 may be joined together by bonding or adhesive, using a time-activated glue, adhesive, bonding agent, or UV light-activated or heat-activated adhesive. In such instances, the damping element 26 may be made from an at least semi-transparent material.

While the spring 28 is shown as a torsion spring, it could alternatively be any other kind of spring such as a helical coil compression spring, and could be one of a plurality of such springs.

While the friction surface 102 is shown as being positioned on the base 30 and the damping structure 23 is provided on the tensioner arm 20 it will be understood that, in other embodiments, the friction surface 102 may be provided on the tensioner arm 20 and the damping structure 23 may be provided on the base 30.

While the above description constitutes a plurality of embodiments, it will be appreciated that these embodiments are examples only and are that they may be subject to further modification without departing from the fair meaning of the accompanying claims.

1. A tensioner, comprising:
a base mountable to an engine;
a tensioner arm pivotally connected to the base for movement about a tensioner arm axis;
a wheel rotatably mounted to the tensioner arm for rotation about a wheel axis, wherein the wheel is engageable with an endless drive member that is driven by the engine;
a tensioner spring connected between the base and the tensioner arm and positioned to urge the tensioner arm towards a free arm position;
a friction surface on one of the base and the tensioner arm; and
a damping structure on the other of the base and the tensioner arm and positioned to engage the friction surface to generate friction during rotation of the tensioner arm relative to the base, wherein the damping structure includes a sleeve that contains at least one aperture and a damping element that contains at least one lug that engages the at least one aperture with no circumferential clearance therebetween.

2. A tensioner as claimed in claim 1, wherein the sleeve is metallic and the damping element is made from a polymeric material.

3. A tensioner as claimed in claim 1, wherein the damping element is overmolded on the sleeve.

4. A tensioner as claimed in claim 1, wherein the at least one lug includes first and second lugs and wherein the damping element includes a dimension-adjustment aperture that is positioned circumferentially between the first and second lugs and the permits adjustment of the circumferential distance between the first and second lugs.

5. A tensioner as claimed in claim 4, wherein the dimension-adjustment aperture is an open ended, axially-extending slot in the damping element.

6. A tensioner as claimed in claim 1, wherein the sleeve is C-shaped and includes a circumferential gap, and wherein the damping element includes a flex portion in the gap so as to permit radial compression and reexpansion of the damping structure during assembly of the tensioner.

7. A tensioner as claimed in claim 1, wherein the at least one aperture in the sleeve is at least one open ended axially extending slot.

8. A tensioner as claimed in claim 1, wherein the damping element includes at least one collection groove extending along a radially outer surface of the damping element, and configured to collect dust and debris during operation of the tensioner.

9. A tensioner as claimed in claim 8, wherein the at least one collection groove is circumferentially aligned with the at least one lug.

10. A tensioner as claimed in claim 1, wherein the at least one aperture is a plurality of apertures arranged in a plurality of rows, wherein the apertures in a first row are circumferentially offset with the apertures in a second row that is axially spaced from the first row.
